(19) United States
(12) Patent Application Publication
(10) Pub. No.: US 2011/0155182 A1
(43) Pub. Date: Jun. 30, 2011

(54) HIGH PRESSURE CLEANER

(75) Inventors: Joseph Kucharczyk, Waterville, OH (US); James D. Reed, Findlay, OH (US); Thomas W. Shields, Perrysburg, OH (US)

(73) Assignee: First Solar, Inc., Perrysburg, OH (US)

(21) Appl. No.: 12/976,568

(22) Filed: Dec. 22, 2010

Related U.S. Application Data
(60) Provisional application No. 61/290,764, filed on Dec. 29, 2009.

(51) Int. Cl. B08B 3/00

(52) U.S. Cl. 134/34; 134/198

(57) ABSTRACT

A method for cleaning a semiconductor material from a photovoltaic module manufacturing component can include enclosing the component and directing a liquid stream at the component.

### CLAIM OF PRIORITY

This application claims priority to U.S. Provisional Patent Application No. 61/290,764, filed on Dec. 29, 2009, which is incorporated by reference in its entirety.

### TECHNICAL FIELD

The present invention relates to photovoltaic module and methods of production.

### BACKGROUND

A photovoltaic module can include semiconductor material deposited over a substrate, for example, with a first layer serving as a window layer and a second layer serving as an absorber layer. Sometimes, it is desirable to remove a semiconductor material from a surface.

### DESCRIPTION OF DRAWINGS

FIG. 1 is a schematic of the high pressure cleaning system.

### DETAILED DESCRIPTION

Manufacturing a photovoltaic module can include creating a plurality of material layers adjacent to a substrate. For example, a photovoltaic module may contain a semiconductor absorber layer formed or deposited over a semiconductor window layer. Each layer may in turn include more than one layer or film. Additionally, each layer can cover all or a portion of the device and/or all or a portion of the layer or substrate underlying the layer. For example, a “layer” can mean any amount of any material that contacts all or a portion of a surface.

An apparatus for making a photovoltaic device includes an enclosure having an interior for containing a controlled environment. There can be at least one deposition station within an enclosure that supplies a material that can be deposited as a layer of semiconductor material onto a surface of a substrate in the enclosure. Semiconductor material can be coated on photovoltaic module manufacturing components, including components of the production line as well as components of the photovoltaic modules being produced. It can be advantageous to clean the semiconductor material from the surfaces of these components.

A method for cleaning a component can include enclosing a photovoltaic module manufacturing component. The photovoltaic module manufacturing component can be at least partially coated with a semiconductor material. The method can include directing a liquid stream at the component. The liquid stream can be pressurized at greater than about 3,500 psi. The method can include removing the semiconductor material from the component with the liquid stream. The liquid can be water. The step of directing a liquid stream at the component can include directing recycled liquid. The step of directing a liquid stream at the component can include directing filtered liquid.

The step of directing a liquid stream at the component can include pressurizing the liquid to between about 5,000 psi and about 75,000 psi. The step of directing a liquid stream at the component can include pressurizing the liquid to between about 10,000 psi and about 60,000 psi. The step of directing a liquid stream at the component can include pressurizing the liquid to between about 30,000 psi and about 60,000 psi. The step of directing a liquid stream at the component can include pressurizing the liquid to between about 35,000 psi and about 55,000 psi. The step of directing a liquid stream at the component can include pressurizing the liquid to between about 45,000 psi to about 50,000 psi. The step of directing a liquid stream at the component can include pressurizing the liquid to about 50,000 psi.

The photovoltaic module manufacturing component can include metal. The semiconductor material can be recycled. The semiconductor material can include cadmium. The method can include collecting the liquid in which the semiconductor material is entrained, separating the semiconductor material from the liquid, and reusing the liquid to remove the semiconductor material from another photovoltaic module manufacturing component. The photovoltaic module manufacturing component can be at least partially coated with a semiconductor material. The step of separating the semiconductor material from the liquid can include filtering the liquid.

A system for cleaning a coated photovoltaic module manufacturing component can include a liquid outlet configured to direct a liquid at greater than about 3,500 psi toward a photovoltaic module manufacturing component and an enclosure configured to contain the photovoltaic module manufacturing component into which the liquid can be directed. The system can include a liquid pressurized to above about 3,500 psi. The liquid can include water. The liquid can include recycled liquid. The liquid can include filtered liquid. The system can include a pump configured to recycle a liquid after cleaning a coated photovoltaic module manufacturing component. The system can include a filter configured to filter a liquid after cleaning a coated photovoltaic module manufacturing component.

The liquid outlet can include a spinning head. The liquid outlet can be capable of directing a liquid toward a photovoltaic module manufacturing component at an angle. The position of the liquid outlet relative to the photovoltaic module manufacturing component can be adjustable. The liquid outlet can be mounted on a robot. The enclosure is airtight. The enclosure can include a filter configured to extract particles from air in the enclosure. The filter can include a high efficiency particulate air (HEPA) filtration system. The filter can include an air scrubbing device.

The liquid can be pressurized to between about 5,000 psi and about 75,000 psi. The liquid can be pressurized to between about 10,000 psi and about 60,000 psi. The liquid can be pressurized to between about 30,000 psi and about 60,000 psi. The liquid can be pressurized to between about 35,000 psi and about 55,000 psi. The liquid can be pressurized to between about 45,000 psi to about 50,000 psi. The liquid can be pressurized to about 50,000 psi. The enclosure can include rinse heads. The photovoltaic module manufacturing component can be at least partially placed inside the enclosure.

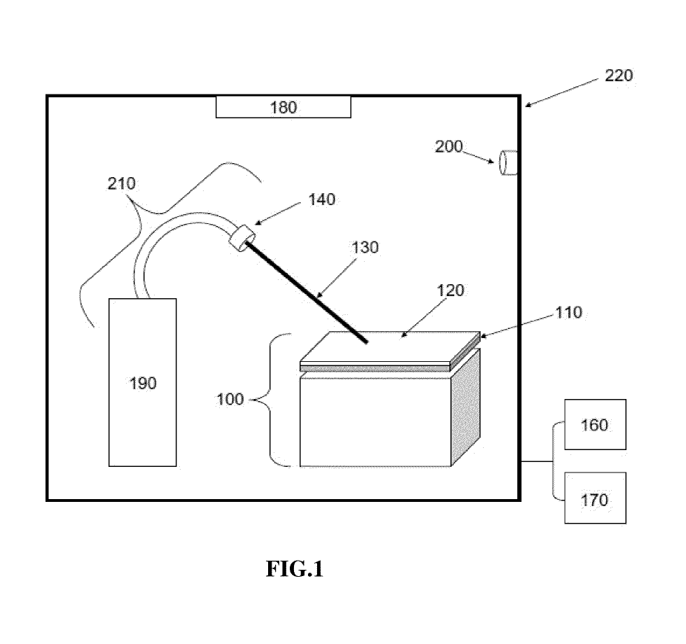

Referring to FIG. 1, a system for cleaning can include a photovoltaic module manufacturing component 100 positioned inside enclosure 220. Photovoltaic module manufacturing component 100 can be any component that can be cleaned, and can include any component having a coating of a material, such as a substrate or a part of a photovoltaic module production line, such as a metal shield. Coated component 110 can be used in a photovoltaic module manufacturing component 100. Coated component 110 can have a coating 120. The coating 120 can include a layer or layers of one or more materials, including one or more semiconductors such as cadmium. Coating 120 can include any material suitable for coating all or part of photovoltaic module manufacturing component 100. Coating 120 can include a semiconductor material. Coating 120 can be capable of being collected and recycled for re-use as a coating material. Coating 120 can include a semiconductor material capable of being recycled.

The system can include cleaner 210, which can include a liquid outlet 140 to direct liquid stream 130 toward coating 120 on coated component 110. Liquid stream 130 can include any suitable liquid. For example, liquid stream 130 can include water. Liquid stream 130 can include any suitable additive to the liquid. For example, liquid stream 130 can include a detergent, a soap, a surfactant, a solvent, a sequestering material, a chelating material, an abrasive material, or any other suitable additive to help remove or recycle coating 120 from coated component 110. Liquid stream 130 can be any suitable temperature. For example, liquid stream 130 can be colder or hotter than the temperature inside enclosure 220. Liquid stream 130 can have a temperature higher than about 50 degrees C. Liquid stream 130 can have a temperature higher than about 80 degrees C.

Liquid stream 130 can include liquid pressurized to any suitable pressure. Liquid stream 130 can be pressurized to above about 3,500 pounds per square inch (psi), so that liquid stream 130 is directed from liquid outlet 140 at a relatively high pressure, which can increase the efficacy of liquid stream 130 in removing coating 120 from coated component 110. Liquid stream 130 can have a pressure between about 5,000 psi and about 75,000 psi. Liquid stream 130 can have a pressure between about 10,000 psi and about 60,000 psi. Liquid stream 130 can have a pressure between about 30,000 psi and about 60,000 psi. Liquid stream 130 can have a pressure between about 35,000 psi and about 55,000 psi. Liquid stream 130 can have a pressure between about 45,000 psi to about 50,000 psi. Liquid stream 130 can have a pressure of about 50,000 psi. Liquid stream 130 can have a pressure sufficient to allow the system to be used as a cutting tool, for example, to cut a material such as a coating, a metal, a mineral, an organic material, a polymer, or any other material suitable for being cut.

Liquid outlet 140 can include a movable head capable of moving in any suitable orientation, velocity, and/or direction. For example, the head can include a spinning head. The spinning head can spin around the axis defined by liquid stream 130. Liquid outlet 140 can be capable of directing liquid stream 130 toward coated component 110 at any suitable angle. Liquid outlet 140 can direct liquid stream 130 at a normal angle (e.g., perpendicular) relative to a surface of coated component 110. Liquid outlet can direct liquid stream 130 at an oblique angle relative to a surface of coated component 110.

Liquid stream 130 can include recycled liquid. For example, recycling system 170 can clean the liquid after cleaning so the liquid can be reused. Recycling system 170 can include any apparatus or part suitable for recycling the liquid from liquid stream 130. For example, recycling system 170 can include a pump configured to pump the liquid back to cleaner 210 for re-use in liquid stream 130. Filtering system 160 can capture one or more coating materials from coating 120 removed by cleaning. Recycling and filtering systems can also be used to recycle and/or filter additives added to liquid stream 130 for re-use. The high pressure liquid method of cleaning does not create a significant amount of waste since the method does not include liquid breakdown, the liquid is recycled and reused, and the only waste being generated is the actual coating material being removed by cleaning. This is unlike other traditional cleaning methods like sand blasting which removes all the materials, but also creates a significant amount of waste due to the sand being broken down, inhibiting its reusability.

The position of liquid outlet 140 and cleaner 210 can be moved relative to coated component 110. For example, coated component 110 can be stationary during cleaning and liquid outlet 140 can be moved relative to coated component 110. Liquid outlet 140 can be stationary during cleaning and coated component 110 can be moved relative to liquid outlet 140. Both liquid outlet 140 and coated component 110 can be moved relative to one another during cleaning. Liquid outlet 140 can be moved by moving cleaner 210. Cleaner 210 can be mounted on a robot 190. Robot 190 can be operatively connected to a controller to control the position and/or orientation and/or on-off status (or any other controllable characteristic) of cleaner 210 in cleaning coated component 110. In one aspect, robot 190 can include a mount for cleaner 210 and the ability to be remotely controlled by a human operator outside enclosure 220. In another aspect, robot 190 can be operatively connected to a microprocessor executing a cleaning algorithm. Any suitable implementation of any suitable controller can be used in connection with robot 190.

Enclosure 220 enclosing cleaner 210 and coated component 110 can protect the operator from the high pressure liquid 130. Enclosure 220 is also meant to contain the mist generated by liquid outlet 140. Enclosure 220 can be sealed to be air tight and include an air filter 180 to filter the air to extract particles (e.g., coating particles) from enclosure 220. Air filter 180 may be a high efficiency particulate air (HEPA) filtration system that can be used on enclosure 220. The air can also be filtered by an air scrubbing device that can be used on enclosure 220. Enclosure 220 can also include rinse heads 200 within enclosure 220 to rinse down the walls of enclosure 220 and to shower the enclosed area with a cleaner such as clean water to minimize both airborne contaminants and residual contaminants on the wall of enclosure 220. Enclosure 220 can be at least partially surrounding the photovoltaic module manufacturing component which is being subjected to the high pressure cleaning.

The embodiments described above are offered by way of illustration and example. It should be understood that the examples provided above may be altered in certain respects and still remain within the scope of the claims. It should be appreciated that, while the invention has been described with reference to the above preferred embodiments, other embodiments are within the scope of the claims.

What is claimed is:

1. A method for cleaning a component, comprising:
enclosing a photovoltaic module manufacturing component, wherein the photovoltaic module manufacturing component is at least partially coated with a semiconductor material;
directing a liquid stream at the component, wherein the liquid stream is pressurized at greater than about 3,500 psi;
removing the semiconductor material from the component with the liquid stream.

2. The method of claim 1, wherein the liquid comprises water.

3. The method of claim 1, wherein the step of directing a liquid stream at the component comprises directing recycled liquid or directing filtered liquid.

4. The method of claim 1, wherein the step of directing a liquid stream at the component comprises pressurizing the liquid to between about 5,000 psi and about 75,000 psi.

5. The method of claim 1, wherein the step of directing a liquid stream at the component comprises pressurizing the liquid to between about 45,000 psi to about 50,000 psi.

6. The method of claim 1, wherein the photovoltaic module manufacturing component comprises metal.

7. The method of claim 1, wherein the semiconductor material comprises cadmium.

8. The method of claim 1, further comprising the steps of
collecting the liquid in which the semiconductor material is entrained;
separating the semiconductor material from the liquid; and
reusing the liquid to remove the semiconductor material from a second photovoltaic module manufacturing component, wherein the second photovoltaic module manufacturing component is at least partially coated with a semiconductor material.

9. The method of claim 8, wherein the step of separating the semiconductor material from the liquid comprises filtering the liquid.

10. A system for cleaning a coated photovoltaic module manufacturing component, comprising:
a liquid outlet configured to direct a liquid at greater than about 3,500 psi toward a photovoltaic module manufacturing component; and
an enclosure configured to contain the photovoltaic module manufacturing component into which the liquid can be directed.

11. A system of claim 10, further comprising liquid pressurized to above about 3,500 psi.

12. A system of claim 10, wherein the liquid comprises water.

13. The system of claim 10, wherein the liquid comprises recycled liquid or filtered liquid.

14. The system of claim 10, further comprising a pump configured to recycle a liquid after cleaning a coated photovoltaic module manufacturing component.

15. The system of claim 10, further comprising a filter configured to filter a liquid after cleaning a coated photovoltaic module manufacturing component.

16. The system of claim 10, wherein the liquid outlet comprises a spinning head.

17. The system of claim 10, wherein the liquid outlet is capable of directing a liquid toward a photovoltaic module manufacturing component at an angle.

18. The system of claim 10, wherein the position of the liquid outlet relative to the photovoltaic module manufacturing component is adjustable.

19. The system of claim 10, wherein the liquid outlet is mounted on a robot.

20. The system of claim 10, further comprising a mist collector configured to collect mist generated as a result of directing a liquid from the liquid outlet.

21. The system of claim 10, wherein the enclosure is airtight and comprises a filter configured to extract particles from air in the enclosure.

22. The system of claim 21, wherein the filter comprises a high efficiency particulate air (HEPA) filtration system or an air scrubbing device.

23. The system of claim 10, wherein the enclosure further comprises rinse heads.

24. The system of claim 10, wherein the photovoltaic module manufacturing component is at least partially placed inside the enclosure.
